(19) United States
(12) Patent Application Publication
(10) Pub. No.: US 2015/0311724 A1
(43) Pub. Date: Oct. 29, 2015

(54) AC INDUCTIVE POWER TRANSFER SYSTEM

(71) Applicant: Evatran Group, Inc., Wytheville, VA (US)

(72) Inventor: Robert Joseph Callanan, Raleigh, NC (US)

(21) Appl. No.: 14/674,857

(22) Filed: Mar. 31, 2015

Related U.S. Application Data
(60) Provisional application No. 61/972,742, filed on Mar. 31, 2014.

(51) Int. Cl. H02J 5/00; H02J 7/02; H02J 17/00

(52) U.S. Cl. CPC H02J 5/005; H02J 17/00; H02J 7/025

(57) ABSTRACT

An inductive power transfer system for device such as a battery charger on an electric vehicle includes a primary circuit having a rectifier and an H bridge inverter connected in parallel to deliver rectified AC voltage to a stationary primary coil of a transformer. The system further includes a secondary circuit on the vehicle including a secondary coil and another rectifier connected in series. AC voltage from a power supply is converted to rectified AC voltage and then transformed into a pulse width modulated high frequency square wave voltage for electromagnetic transfer from the primary coil to the secondary coil. The square wave voltage is converted back to AC voltage for delivery to a vehicle charger.

This application claims the benefit of U.S. provisional patent application No. 61/972,742 filed Mar. 31, 2014.

### BACKGROUND OF THE INVENTION

Electric vehicles include batteries which must be charged regularly, typically every day. For many consumers, remembering to plug the vehicle into a battery charging system at the end of the day is a major inconvenience. For others, there is apprehension in handling a 240V AC (alternating current) power supply, particularly in wet conditions. Inductive charging overcomes many of the issues of prior plug-in charging systems because there is no need to physically handle the plug every day to charge the vehicle batteries. Inductive charging provides hands-free automatic charging when the vehicle is parked adjacent to a charging pad.

### BRIEF DESCRIPTION OF THE PRIOR ART

FIG. 1 illustrates a DC (direct current) inductive power transfer system which utilizes a transformer 2 including a stationary primary coil 4 and a secondary coil 6 mounted on a device such as an electric vehicle. The stationary coil is arranged in a parking pad 8 mounted on the floor of a garage where the vehicle is normally parked. A control panel 10 is supplied with AC voltage and includes a rectifier 12 which converts the voltage to DC and an inverter 14 which creates a pulse width modulated high frequency square wave voltage to drive the primary coil. A large link capacitor 16 is arranged between the rectifier and inverter and filters the rectified AC into DC. The high frequency AC is magnetically coupled from the parking pad to a vehicle adapter 18 via the coils of the transformer. The secondary coil is connected with a rectifier 20 and another large link capacitor 22 to generate a DC voltage which is delivered to a battery charger.

While the DC inductive charging system operates satisfactorily, it suffers certain inherent drawbacks. One such drawback is that it does not provide power factor conversion. Therefore, the RMS current draw is approximately 1.67 times greater than necessary. Accordingly, a 30 ampere service is required for a 3.3 KW system as compared to 20 ampere service for a 3.3 KW system with power factor correction. Another drawback is that the vehicle charger is designed to accept AC input and perform power factor correction. Compatibility with a DC input is not a design consideration which might lead to inoperability of the charger which limits compatible applications.

### SUMMARY OF THE INVENTION

The subject AC power transfer system generates AC voltage used to power a device such as a battery charger on an electric vehicle to charge the vehicle batteries. The system includes a transformer including a stationary primary coil and a secondary coil mounted on the vehicle. When the vehicle is parked adjacent to the primary coil, inductive charging occurs. A primary circuit is connected between an AC power supply and the stationary primary coil. The primary circuit includes a rectifier which converts AC voltage to rectified AC voltage and a high frequency bridge inverter that creates a pulse width modulated square wave voltage to drive the primary coil. The rectifier and inverter are connected in parallel with the primary coil.

According to a preferred embodiment, a reactor is connected in series between the output of the bridge inverter and the primary coil. In addition, the bridge inverter is an H bridge formed of transistors. A link capacitor is also connected in series between the rectifier and the H bridge to filter the rectified AC voltage.

The secondary circuit includes a secondary coil inductively coupled with the primary coil to receive the square wave voltage from the primary circuit. A rectifier is connected in series with the secondary coil to convert the high frequency AC voltage to a rectified AC voltage and a low frequency bridge inverter converts the rectified AC voltage to an AC voltage which is used by the battery charger to charge the vehicle batteries. The secondary circuit also includes a link capacitor connected in series with the secondary circuit rectifier.

### BRIEF DESCRIPTION OF THE FIGURES

Other objects and advantages of the invention will become apparent from a study of the following specification when viewed in the light of the accompanying drawing, in which:

FIG. 1 is a circuit diagram of a DC inductive power transfer systems, respectively, according to the prior art;

FIG. 2 is a circuit diagram of an AC inductive power transfer system;

FIG. 3 is a circuit diagram of a preferred AC inductive power transfer system;

FIGS. 4a-d are graphical representations of the control panel waveforms for the primary circuit at the panel input from the AC voltage supply, at the rectifier output, at the inverter input, and at the inverter output, respectively;

FIGS. 5a-c are graphical representations of vehicle adapter waveforms for the secondary circuit at the high frequency AC input, the filtered rectifier output, and the inverter output, respectively; and

FIG. 6 is a graphical representation of the vehicle adapter inverter output voltage.

### DETAILED DESCRIPTION

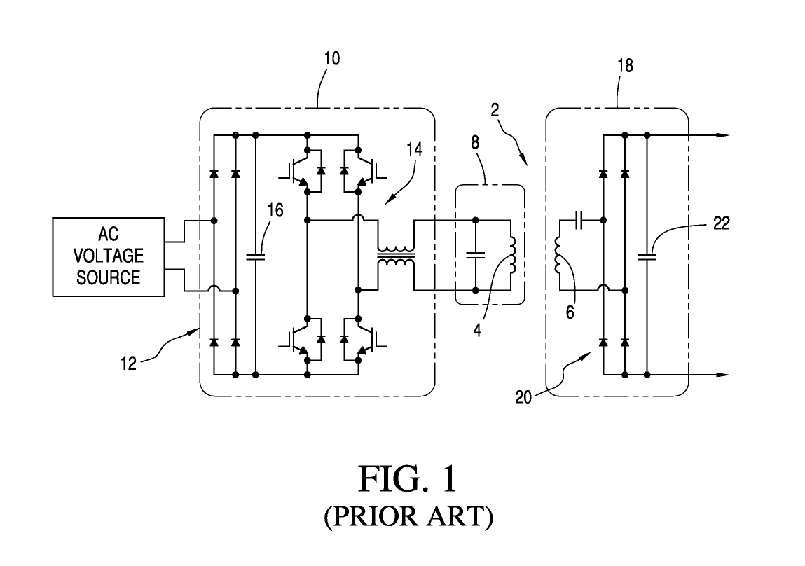

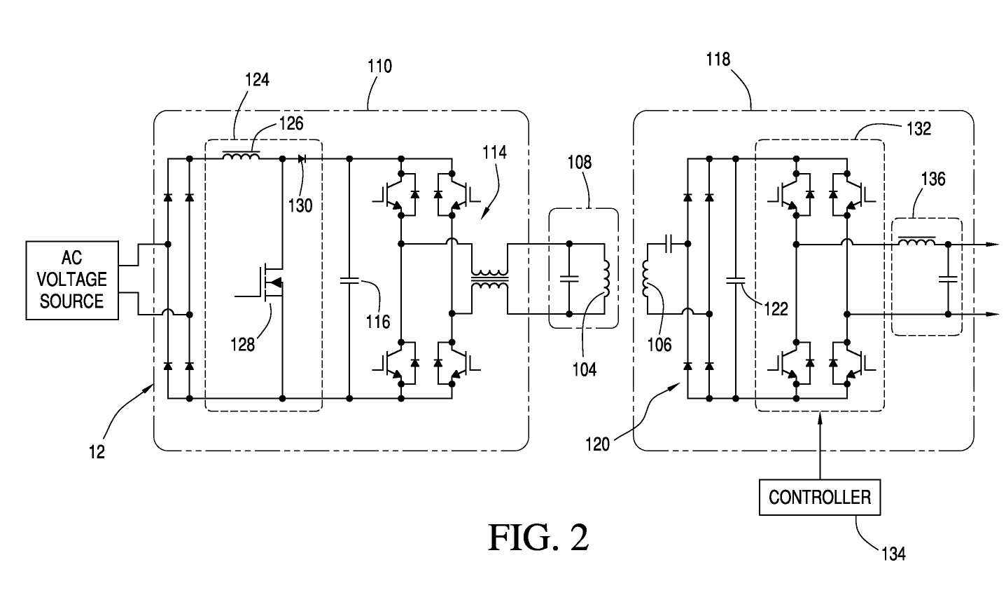

Referring first to FIG. 2, there is shown an AC inductive power transfer system for a device such as the charging system for an electric vehicle. The AC input voltage from a voltage source is rectified by a rectifier 112 and feeds a power factor correction (PFC) circuit 124 including an inductor 126, a transistor 128, and a diode 130. The output of the PFC circuit provides DC to a link capacitor 116 which is preferably half the size of the link capacitor of the DC system shown in FIG. 1. The DC feeds an inverter 114 to create high frequency pulse width modulated AC that drives the primary coil 104 in the parking pad 8. The high frequency AC is magnetically coupled to the secondary coil 106 of the vehicle adapter where it is rectified back into DC by the rectifier 120. The DC is fed to another high frequency AC inverter 132 that creates a pulse width modulated output. The inverter controller 134 adjusts the pulse width modulated output to be proportional to a line frequency sine wave. An output filter 136 filters the high frequency content from the inverter output resulting in a line frequency sinusoidal AC voltage to feed the vehicle charger. Additional control circuitry (not shown) is required to operate the new power circuits.

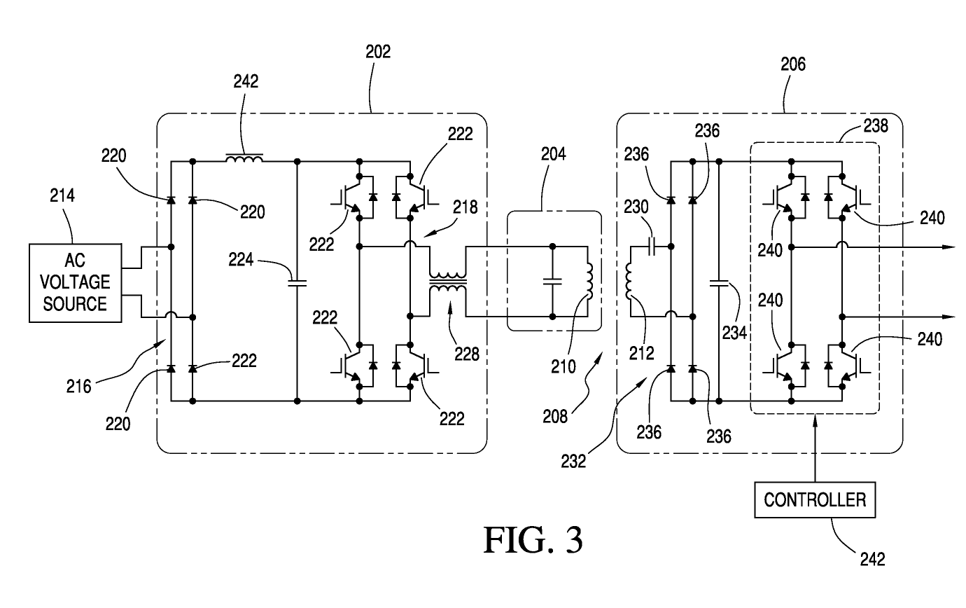

FIG. 3 illustrates a preferred embodiment of an inductive charging system for a device such as the charging system for an electric vehicle. The system includes circuitry arranged in three components: a control panel 202, a stationary parking pad 204, and a vehicle adapter 206. The control panel is typically mounted on the wall of a vehicle owner's garage. It is connected with the parking pad which is mounted on the floor of the garage in the region where an electric vehicle is routinely parked. The vehicle adapter is mounted on the electric vehicle. When the vehicle is not in use and parked in the garage above the parking pad, the inductive power transfer system charges a battery charger on the vehicle which in turn charges the batteries used in the vehicle to power the engine. Inductive charging is accomplished via a transformer 208 by way of an energy transfer between a stationary primary coil 210 arranged within the parking pad 204 and a secondary coil 212 mounted within the vehicle adapter 206.

The control panel 202 is connected with an AC voltage source 214. The control panel includes a primary circuit which is connected with the stationary primary coil. More particularly, the primary circuit includes a rectifier 216 connected with the AC voltage source and a high frequency inverter 218 connected in parallel with the rectifier. The rectifier is formed from a capacitor bank or a plurality of diodes 220 connected in a known manner. The inverter includes a bridge of transistors 222 such as metal oxide semiconductor field effect transistors (MOSFETs) or insulated gate bipolar transistors (IGBTs). The transistors are preferably connected to form an H bridge inverter as shown, although a half bridge inverter may be used as well. A link capacitor 224 is connected in parallel with and between the rectifier and the inverter.

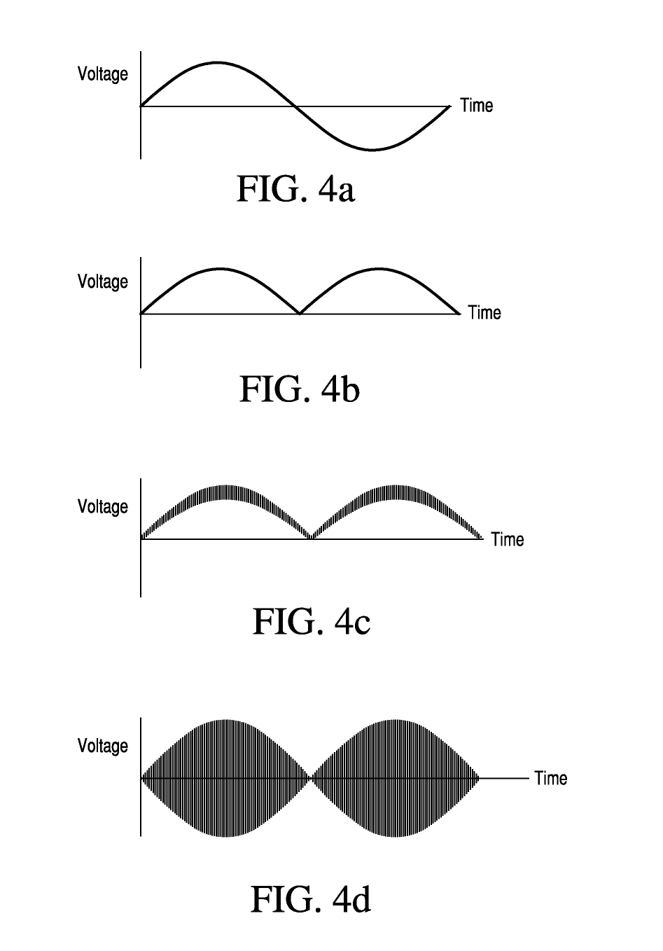

FIG. 4a shows the voltage waveform at the output of the AC voltage source 214 which is the input to the primary circuit in the control panel. The rectifier 216 of the primary circuit converts the AC voltage to rectified AC resulting in the waveform shown in FIG. 4b which is from the output of the rectifier. The link capacitor 224 filters the rectifier output resulting in the waveform shown in FIG. 4c which is the input voltage to the inverter 218. The rectified AC output from the link capacitor is delivered to the inverter which creates a pulse width modulated high frequency square wave voltage shown in FIG. 4d to drive the primary coil 210 of the parking pad. A further capacitor 226 is connected in parallel with the primary coil.

A reactor 228 in the form of an inductor is connected in series with the output of the inverter. The reactor limits the current output of the inverter so that the capacitor 224 is not a short circuit on the output of the inverter. The reactance of the reactor comprises an imaginary part of the coupling impedance, i.e. the impedance at the output of the inverter. This can be referred to as the reactive or imaginary part of the equivalent series impedance. By selecting the inductance of the reactor, the insertion reactance of the system can be controlled.

In one embodiment, the inductance of the reactor is chosen to be equal to the inductance of the stationary primary coil 210. The insertion reactance is then minimized at the resonant frequency of the system, i.e. the primary 210 and secondary 212 coils of the system transformer. This is true independent of the coupling coefficient between the primary and secondary coils, defined as

k=LM/√(Lp*Ls)

where LM is the mutual inductance;

Lp is primary inductance; and

Ls is secondary inductance.

The benefit of minimizing the reactive impedance is that the output voltage of the secondary is independent of the load applied. This creates a stiff source of voltage to the vehicle charger. Stiff voltage is defined as a voltage which is only dependent on the input voltage and the coupling ratio, and independent of the load value.

Accordingly,

Vout=Vin*k

where Vout is the output voltage to the vehicle charger; and

Vin is the voltage output from the inverter.

This equation is valid where the primary and secondary coils have substantially the same inductance. If the coils are not substantially the same inductance, then

Vout =Vin*k*C

where C is a constant which is dependent on the self-inductance values of the primary and secondary coils.

C also depends on the construction details of the coils. C is independent of load.

Under these conditions, the vehicle coil 212 can be significantly misaligned relative to the stationary primary coil 210 (wide variation of the value of k), while the output voltage to the vehicle charger remains stable with respect to changes of the output load and the system is driven at a fixed frequency.

In another embodiment, the inductance of the reactor is chosen to be different from, i.e. above or below, the inductance of the primary coil. The insertion reactance is then minimized at a frequency which is dependent on the value of k. The stiff voltage output will be at a frequency which may be the resonant frequency of the system or another drive frequency.

The reactor balances the differential mode currents in the charging system to reduce radiated emissions and losses in the system. In a preferred embodiment, the reactor comprises a dual winding over a gapped iron core to balance common and differential mode currents on both sides of the charging system and to control the electromagnetic field for controlling radiated emissions. In alternate embodiments, air, ferrite, amorphous material, or nano-crystalline cores may be used for the reactor, with single or dual windings.

The rectifier 216 creates a pulsating rectified AC voltage. The input reactor 228 and small link capacitor 224 create a low-pass filter that prevents the high frequency AC voltage generated from the inverter 218 from going back onto the AC voltage source 114. The inverter is fed with the pulsating rectified AC voltage with a small high frequency component. The link capacitor 224 is sized to manage the amount of high frequency ripple present at the inverter input terminals to insure that the inverter switches are not subjected to an overvoltage. The size of this capacitor is very small, approximately 1/1000 of the capacitance needed in the AC system approach described above with reference to FIG. 2 since there is no attempt to filter off the line frequency components. Feeding the high frequency inverter with this pulsating rectified AC voltage produces an amplitude-modulated high frequency AC output as shown in FIG. 4d. The modulation envelope matches the waveform observed on the AC input terminals. This modulated high frequency AC is converted to a matching magnetic field in the primary coil 210 of the parking pad.

A secondary circuit is arranged within the vehicle adapter 206 and includes a capacitor 230 and rectifier 232 connected in series with the secondary winding 212 and a link capacitor 234 connected in parallel with the rectifier. Like the rectifier in the primary circuit, the secondary circuit rectifier may be formed from a capacitor bank or a plurality of diodes 236. The secondary circuit rectifier converts the high frequency AC output from the secondary coil 212 to a rectified AC output. The secondary circuit further includes a low frequency inverter 238 connected with the output of the rectifier 232. The inverter is preferably in the form of an H bridge including a plurality of transistors 240 such as MOSFETs or IGBTs, similar to the inverter 218 of the primary circuit. A half-bridge inverter may be used in place of the H bridge. A controller 242 is connected with the low frequency inverter and is used to reconstruct the sine wave from the rectified AC by inverting the polarity of the rectified AC every half cycle. The controller provides appropriately phased drive signals to the low frequency inverter 238 so that the output polarity from the inverter is reversed at the rectified AC minimums. That is, the inverter controller locks the phase of the output signal to that of the input signal by switching the inverter at the zero-crossing/low points of the rectified AC waveform to reconstruct the original AC waveform on the output. The output from the inverter is delivered to the transfer device such as a charger for the batteries of an electric vehicle.

In the embodiment shown in FIG. 3, the reactor 228 and transformer 208 operate as a wireless coupling network to connect the output of the control panel inverter 218 with the rectifier bridge 232 in the vehicle adapter 206. It will be appreciated by those of ordinary skill in the art that other wireless coupling network embodiments would work equally well, with or without additional reactors. Examples of other coupling networks include series-series, series-parallel, parallel-parallel networks or other combinations of components that can perform a wireless transfer function.

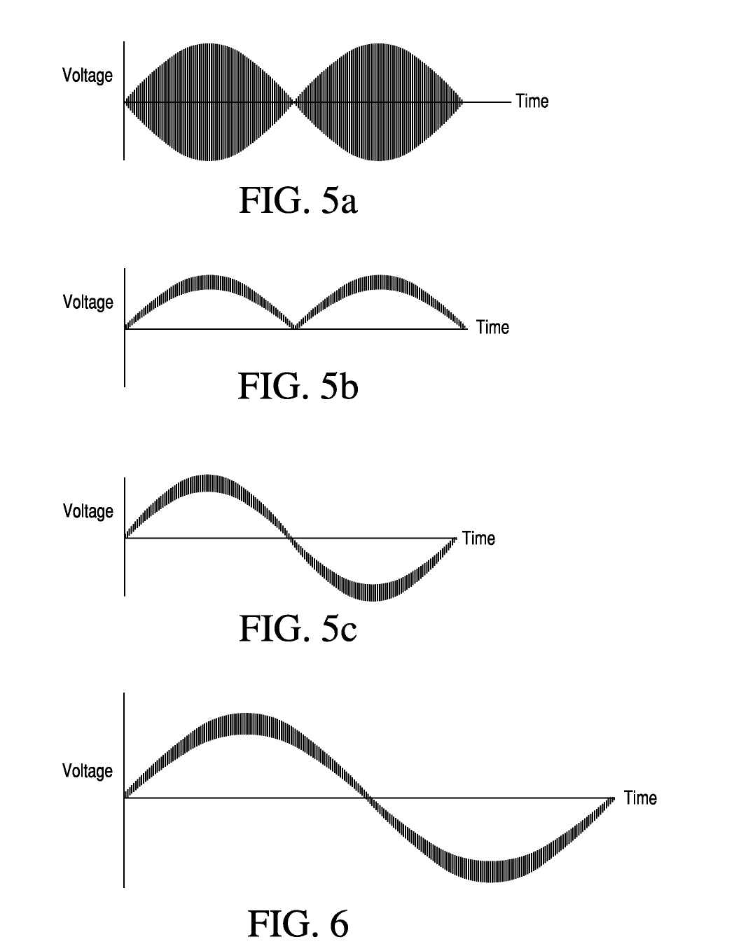

The voltage waveforms in the vehicle adapter are shown in FIGS. 5a-c. The first waveform shown in FIG. 5a is the line frequency modulated high frequency signal delivered magnetically from the parking pad. Rectifying and filtering this signal results in a pulsating rectified AC waveform that follows the AC source voltage plus a small amount of high frequency ripple. The high frequency component is managed by the small link capacitor 234. As in the control panel, this capacitor is selected to insure that the vehicle adapter inverter transistors are not subjected to an overvoltage. The size of this capacitor is very small, approximately 1/500 of the capacitance required in the AC approach described with reference to FIG. 2 since there is no attempt to filter the line frequency AC voltage. This signal is fed to the vehicle adapter inverter that creates the AC output that feeds the onboard charger. Further filtering can be done to minimize the amount of high frequency content if needed. This filter would be smaller than one needed in the standard AC approach since the high frequency content is significantly less.

The AC voltage is essentially chopped up at high frequency to be magnetically coupled from the parking pad to the vehicle adapter and reassembled to feed the onboard charger. The onboard charger includes a power factor correction which makes the charger load characteristics a pure resistance so that the current wave shape will track the input AC signal. This is reflected back through the vehicle adapter to the parking pad to the control panel to the voltage source as a sinusoid with a small high frequency ripple component as shown in FIG. 6.

In an alternate embodiment, the primary circuit within the control panel 202 includes an inductor 242 connected in series between the rectifier 216 and the link capacitor 224 to provide rectified voltage to the link capacitor.

In operation, AC power is provided to the control panel and is rectified by the rectifier 216 of the primary circuit. The link capacitor 224 filters the rectified AC into rectified AC. The rectified AC output from the filtering capacitor is delivered to an inverter that creates a pulse width modulated high frequency square wave voltage to drive the parking pad. The high frequency rectified AC is magnetically coupled from the parking pad coil to the vehicle adapter coil where it is rectified back into rectified AC by the secondary circuit rectifier 232. The line frequency inverter 238 in the secondary circuit modifies the voltage waveform from the rectifier and feeds the battery charger on the vehicle. The coupling network at the output of the high frequency inverter 218 provides load regulation of the system secondary output voltage. In the illustrated embodiment where a reactor is used in the coupling network, a dual wound reactor balances differential mode currents on both sides of the system. An iron core reactor controls the stray magnetic field to improve radiated emissions.

As compared to prior AC power transfer system, the present system eliminates the need for a separate power factor correction circuit (including a high power MOSFET, diode and associated heat sinks and controls) in the control panel. The size of the link capacitors in the primary and secondary circuits is significantly reduced. The line frequency inverter in the secondary circuit eliminates switching losses and the associated impacts on the heat sink in comparison to the high frequency inverter in prior systems. In addition, the power factor correction filter in the secondary circuit is eliminated.

While the preferred forms and embodiments of the invention have been illustrated and described, it will be apparent to those of ordinary skill in the art that various changes and modifications may be made without deviating from the inventive concepts set forth above.

What is claimed is:

1. An inductive power transfer system, comprising
(a) a transformer including a stationary primary coil and a receiving secondary coil mounted on a device to receive power;
(b) a primary circuit connected between an AC voltage source and said stationary primary coil, said primary circuit including a rectifier and a bridge inverter connected in parallel with said inductor primary coil to produce a rectified AC voltage; and
(c) a secondary circuit including a rectifier and a bridge inverter connected in parallel with said receiving secondary coil to produce an AC output.

2. An inductive power transfer system as defined in claim 1, wherein said primary and secondary circuit bridge inverters each comprise a plurality of transistors.

3. An inductive power transfer system as defined in claim 2, wherein primary and secondary circuit bridge inverters each comprise an H bridge.

4. An inductive power transfer system as defined in claim 3, wherein said H bridges comprises four transistors.

5. An inductive power transfer system as defined in claim 3, wherein said transistors comprise one of metal oxide semiconductor field effect transistors and insulated gate bipolar transistors.

6. An inductive power transfer system as defined in claim 3, and further comprising a reactor connected in series between an output of said primary circuit H bridge and said stationary primary coil.

7. An inductive power transfer system as defined in claim 7, and further comprising a capacitor connected in parallel with said stationary primary coil and a capacitor connected in series with said receiving secondary coil.

8. An inductive power transfer system as defined in claim 6, wherein said reactor has an inductance equivalent to a self-inductance of said primary stationary coil.

9. An inductive power transfer system as defined in claim 6, wherein said reactor has an inductance which is above a self-inductance of said stationary primary coil.

10. An inductive power transfer system as defined in claim 6, wherein said reactor has an inductance which is below a self-inductance of said stationary primary coil.

11. An inductive power transfer system as defined in claim 6, wherein said reactor includes at least one of an iron, ferrite, amorphous material, nano-crystalline, and air core.

12. An inductive power transfer system as defined in claim 11, wherein said reactor comprises dual identical coils on the same core.

13. An inductive power transfer system as defined in claim 11, wherein said reactor comprises a pair of identical separate cores, each of said cores having a single winding.

14. An inductive power transfer system as defined in claim 6, wherein said primary and secondary circuit rectifiers each comprise a capacitor bank.

15. An inductive power transfer system as defined in claim 6, wherein said primary and secondary circuit rectifiers each comprise a plurality of diodes.

16. An inductive power transfer system as defined in claim 6, and further comprising a link capacitor connected in parallel between said primary circuit rectifier and said H bridge.

17. An inductive power transfer system as defined in claim 16, and further comprising a link capacitor connected in series with said secondary circuit rectifier.

18. An inductive power transfer system as defined in claim 16, wherein said primary circuit further comprises a power factor correction circuit between said rectifier and said link capacitor.
